(19) United States
(12) Patent Application Publication
(10) Pub. No.: US 2008/0274377 A1
(43) Pub. Date: Nov. 6, 2008

(54) Resin artcraft with electric conduction function and method of manufacturing the same

(76) Inventor: Cheng-Chen Lin, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 11/797,242

(22) Filed: May 2, 2007

(51) Int. Cl. B32B 9/00; C04B 35/01

(52) U.S. Cl. 428/702; 264/104; 427/58

(57) ABSTRACT

A method of manufacturing a resin artcraft with an electric conduction function includes the steps of: coating an electrically conductive material onto a resin semi-finished good; baking the resin semi-finished good at a predetermined temperature for a predetermined time to form a conductive layer on the electrically conductive material; baking the resin semi-finished good at a predetermined temperature for a predetermined time again after an anti-oxidant material is coated onto the conductive layer, such that the anti-oxidant material is melted with the conductive layer to form an alternate layer, and a portion of the electrically conductive material is permeated into the alternate layer. By baking the electrically conductive material and anti-oxidant material coated separately onto the resin semi-finished good, the conductive layer can be made by using a minimum quantity of electrically conductive material, and the oxidation rate of the conductive layer exposed in air can be retarded significantly.

### FIELD OF THE INVENTION

The present invention relates to a resin artcraft, and more particularly to a resin artcraft with an electric conduction function and a method of manufacturing the same.

### BACKGROUND OF THE INVENTION

As our living environment is a diversified society, and we are living in an innovative changing era, various different products are introduced constantly to the market to meet consumer needs. These products which are indispensable to our life bring us tremendous convenience, particularly the daily products which are used extensively daily, and thus consumers have increasingly higher demands on daily products, and it becomes one of the important indexes for evaluating whether or not the living standard and the manufacturing technology of a country leads the others by their capability of providing more convenient daily products and efficient services in the future, as well as taking user-friendliness in the design of its products into consideration.

At present, innovative daily products are developed constantly. For example, a table lamp made of resin is manufactured by injection molding to form a lamp of a specific shape, and the table lamp includes a circuit board and a light bulb for providing light, and a conducting paint is coated onto the surface of the table lamp to form a conducting film, and then the conducting paint is electrically connected to the circuit board, so as to complete the manufacture of a table lamp that no longer needs a press switch, and users can turn on or off the lamp by simply touching the lamp. If a user touches the conducting film, the circuit of the circuit board will be connected, and electric power will be supplied to the light bulb, so that the light bulb emits a light source. The stylish design and operation of touch control lamps are much better than those of the traditional lamps, and the touch control lamps can bring us fresh feeling and convenience, and thus such lamps become very popular.

In general, the manufacturing method of this kind of table lamps mainly includes the steps of injecting a melted resin into a mold, performing a cooling process to solidify the resin, removing the solidified resin from the mold to produce a semi-finished good of a table lamp, coating a layer of conducting paint onto a surface of the semi-finished good to form a conducting film, and coating the conducting paint onto the conducting film again after the conducting film is formed and dried in the shade, such that the conducting film can reach a predetermined thickness. The table lamp so produced has a space reserved for installing a lighting circuit board and a lamp bulb, and the lighting circuit board and lamp bulb are electrically coupled with the conducting film.

However, the foregoing conventional table lamps still have the following drawbacks in their application:

1. After the use of the lamp for about half a year, the conducting film on the surface of the lamp has been exposed in air for a long time and oxidized, so that the lamp cannot be used anymore. To solve this problem, most manufacturers coat a specific thickness of conducting paint on the lamp in order to retard the oxidation rate of the conducting film. However, such method will incur a much higher manufacturing cost of a regular table lamp.

2. After the conducting film is coated on the surface of a semi-finished good of the table lamp, the transparent paint is coated on the conductive layer to form an insulating layer after the transparent paint is dried in the shade. Although the area of the conducting film exposed in air cannot be reduced to retard the oxidation rate of the conducting film in air, yet the conductive layer is covered completely by the insulating layer, and the conductive layer loses its function of connecting to the outside for producing static charges.

3. If the conducting paint and the transparent paint are mixed into a mixed paint, and the mixed paint is coated onto the surface of the semi-finished good of the table lamp, and the insulating layer is formed either by drying in shade or baking at a high temperature, there will be two problems: (1) An electrical potential difference cannot be produced by touching the insulating layer, and thus a touch control lamp cannot be made; (2) The semi-finished good of the table lamp is made of resin which cannot stand a high temperature of over 50° C., and thus the conducting film cannot be made by the baking method.

Therefore, it is an important subject to change the manufacturing process, so that the semi-finished good of the table lamp made of resin can be baked at a temperature higher than 50° C. and the quantity of the conducting paint can be minimized, and the oxidation of the conducting film can be retarded.

### SUMMARY OF THE INVENTION

In view of the foregoing shortcomings of the prior art, the inventor of the present invention based on years of experience in the related industry to conduct extensive researches and experiments, and finally developed a resin artcraft with an electric conduction function and a method of manufacturing the same.

It is a primary objective of the present invention to provide a method of manufacturing a resin artcraft with an electric conduction function, and the method comprises the steps of: coating an electrically conductive material onto a surface of resin semi-finished good; baking the resin semi-finished good at a predetermined temperature for a predetermined time to form a conductive layer on the surface of the electrically conductive material; baking the resin semi-finished good at a predetermined temperature for a predetermined time again after an anti-oxidant material is coated onto the conductive layer, such that the anti-oxidant material on the conductive layer is melted together with the conductive layer to form an alternate layer, and a portion of the electrically conductive material is permeated into a surface of the alternate layer to manufacture a resin artcraft. By baking the electrically conductive material and the anti-oxidant material which are coated separately onto the surface of the resin semi-finished good, we can form the conductive layer by using a minimum quantity of electrically conductive material, and greatly retard the oxidation rate of the conductive layer exposed in air.

Another objective of the present invention is to provide a resin artcraft with an electric conduction function, and the resin artcraft comprises a casing, an alternate layer and an electric conduction circuit, wherein the casing is made of a resin and a stone powder, and the alternate layer is disposed on a surface of the casing, and made of an electrically conductive material melted with an anti-oxidant material, and the electrically conductive material is attached onto a surface of the casing, and a portion of the electrically conductive material is permeated into a surface of the alternate layer, and the electric conduction circuit is installed in the casing and electrically coupled to the electrically conductive material in the alternate layer. Since the area of the electrically conductive material in contact with air is very small, the present invention can greatly retard the oxidation of the electrically conductive material in air.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a flow chart of a manufacturing procedure of the present invention;

FIG. 2 is a flow chart of a manufacturing procedure of a resin semi-finished goods of the present invention; and

FIG. 3 is a cross-sectional view of a surface of a resin artcraft of the present invention.

### DETAILED DESCRIPTION OF THE PREFERRED EMBODIMENTS

The present invention relates to a method of manufacturing a resin artcraft with an electric conduction function, and the method comprises the steps of: coating an electrically conductive material (such as a transparent paint) on a surface of a resin semi-finished good, wherein the electrically conductive material is coated with a thickness of 0.01-0.1 cm; baking the resin semi-finished good at a predetermined temperature for a predetermined time to form a conductive layer on the surface of the resin semi-finished good; baking resin semi-finished good at a predetermined temperature for a predetermined time again after an anti-oxidant material (such as a transparent paint) is coated onto the conductive layer, in order to melt the anti-oxidant material on the conductive layer with the conductive layer to form an alternate layer; permeating a portion of the electrically conductive material into a surface of the alternate layer to manufacture the resin artcraft with an electric conduction function.

If a user touches the alternate layer of the resin artcraft, the electrically conductive material disposed densely on the alternate layer will be permeated into a surface of the alternate layer surface, and thus an electric potential difference of static charges will be produced at the position where the user touches the conductive layer for controlling the connection or disconnection of a circuit in the resin artcraft. Therefore, only a small quantity of electrically conductive material is needed to be coated on the surface of the resin semi-finished good surface, so as to avoid wasting electrically conductive materials, and greatly lower the material cost. Since the contact area of the electrically conductive material permeated into the alternate layer surface with air is reduced significantly, the electrically conductive material exposed in air for a long time will not be oxidized easily, and the lifetime of the resin artcraft with an electric conduction function can be extended.

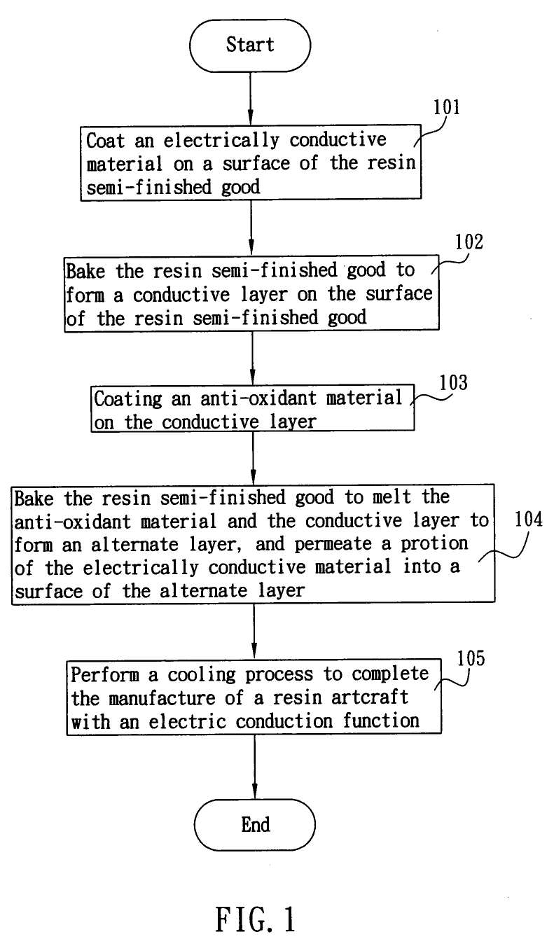

Referring to FIG. 1 for a method of manufacturing a resin artcraft with an electric conduction function in accordance with the present invention, the method comprises the steps of:

(101) coating the electrically conductive material on a surface of the resin semi-finished good;

(102) baking the resin semi-finished good to form the conductive layer on the surface of the resin semi-finished good;

(103) coating the anti-oxidant material on the conductive layer;

(104) baking the resin semi-finished good to melt the anti-oxidant material and the conductive layer to form an alternate layer, and permeating a portion of the electrically conductive material into a surface of the alternate layer; and

(105) performing a cooling process to complete the manufacture of a resin artcraft with an electric conduction function.

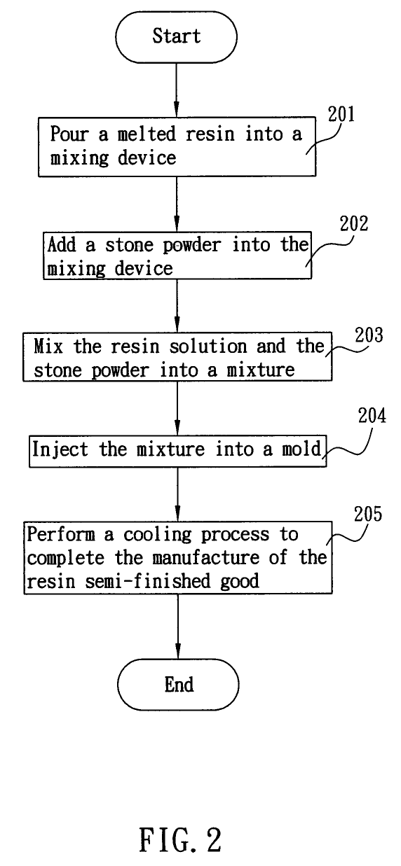

Referring to FIG. 2 for a preferred embodiment of the present invention, the resin semi-finished good is manufactured by a procedure comprising the steps of:

(201) pouring a melted resin into a mixing device;

(202) adding a stone powder into the mixing device;

(203) mixing the resin solution and the stone powder into a mixture;

(204) injecting the mixture into a mold; and

(205) performing a cooling process to complete the manufacture of the resin semi-finished good.

Since the resin semi-finished good is made by adding stone powder (such as marble powder), the resin semi-finished good can be baked at a high temperature without being softened or deformed.

In this embodiment, the method bakes the resin semi-finished good at 60˜120° C. (preferably at 100° C.) for 5˜20 seconds to form the conductive layer after the electrically conductive material is coated, and bakes the resin semi-finished good again at 60˜120° C. (preferably at 100° C.) for 5˜20 seconds to melt the conductive layer and the anti-oxidant material after the anti-oxidant material is coated onto the conductive layer. When the anti-oxidant material is changed gradually from a liquid into a solid, the alternate layer is formed and attached onto a surface of the conductive layer and the alternate layer, and the electrically conductive material is permeated evenly towards the outside of the alternate layer, so that a portion of the electrically conductive material is permeated into a surface of the alternate layer to form an intricate conducting structure in the alternate layer.

Since the electrically conductive material in the form of a plurality of small dots disposed on the surface of the alternate layer, the contact area of the electrically conductive material permeated into a surface of the alternate layer surface with air can be reduced greatly, and the oxidation rate of the electrically conductive material by air can be retarded significantly. On the other hand, a conventional conducting film does not come with a protection by the alternate layer, and the conducting film will be oxidized rapidly by the air when it is exposed in air. The oxidation rate of the conventional conducting film is faster than that of the present invention, even if a thick layer of electrically conductive material is coated onto the conducting film.

After the resin semi-finished good is manufactured by the method in accordance with this embodiment of the invention, a dye can be put into the electrically conductive material before the electrically conductive material is coated onto the surface of the resin semi-finished good, if a user wants to have different colors of the resin semi-finished good. After the dye and the electrically conductive material are mixed, the electrically conductive material of different colors is produced, and coated onto the resin semi-finished good, such that the surface of the resin semi-finished good has different colors to enhance the vivid visual effect of the resin artcraft.

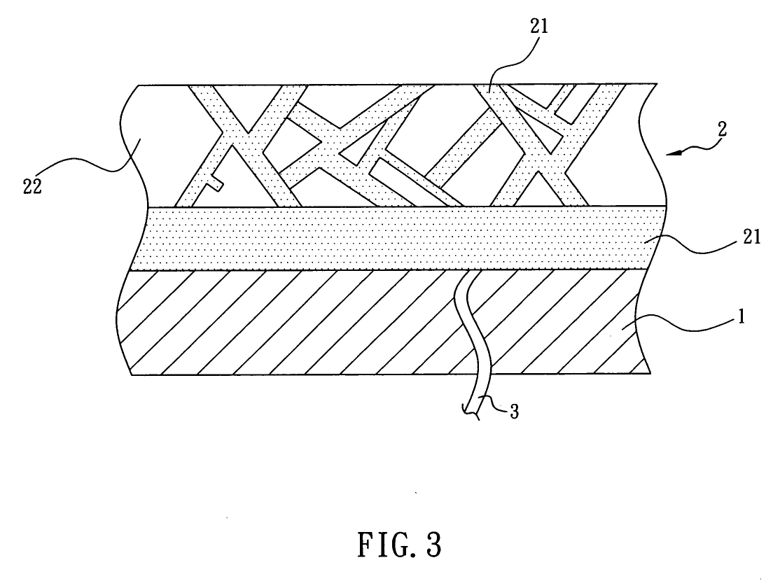

Referring to FIG. 3 for a resin artcraft with an electric conduction function of the present invention, the resin artcraft comprises a casing 1, an alternate layer 2 and an electric conduction circuit 3, wherein the casing 1 is made of a resin and a stone powder, and the alternate layer 2 is disposed on a surface of the casing 1, and the alternate layer 2 is made of an electrically conductive material (such as a conducting paint) 21 melted with an anti-oxidant material (such as a transparent paint) 22, and the electrically conductive material 21 is attached onto a surface of the casing 1, and a portion of the electrically conductive material 21 is passed through the anti-oxidant material 22, and intricately permeated into a surface of the alternate layer, such that a plurality of dots are formed on the resin artcraft, and the electric conduction circuit 3 is installed in the casing 1 and electrically coupled with the electrically conductive material 21 in the alternate layer 2.

If a user touches the electrically conductive material 21 that is permeated into a surface of the alternate layer 2, an electric potential difference of the electrically conductive material 21 will be changed for connecting or disconnecting the electric conduction circuit 3 electrically coupled with the electrically conductive material 21. Furthermore, the resin artcraft is made of the stone powder and capable of standing a temperature over 50° C., such that electronic components or circuit installed in the resin artcraft can stand a high temperature produced by the electric connection for a long time, and the resin artcraft will not be softened or damaged. Since the contact area of the electrically conductive material 21 with air is very small, therefore the oxidation of the electrically conductive material 21 in air can be delayed greatly.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method of manufacturing a resin artcraft with an electric conduction function, comprising the steps of:
coating an electrically conductive material on a surface of a resin semi-finished good;
baking said resin semi-finished good to form a conductive layer of the surface of said resin semi-finished good;
coating an anti-oxidant material on said conductive layer; and
baking said resin semi-finished good to melt said anti-oxidant material and said conductive layer to form an alternate layer, and permeate a portion of said electrically conductive material into a surface of said alternate layer to manufacture said resin artcraft with an electric conduction function.

2. The method of manufacturing a resin artcraft with an electric conduction function of claim 1, wherein said resin semi-finished good is manufactured by a procedure comprising the steps of:
pouring a melted resin into a mixing device;
adding a stone powder into said mixing device;
mixing said melt resin and said stone powder into a mixture;
injecting said mixture into a mold; and
performing a cooling process to manufacture said resin semi-finished good.

3. The method of manufacturing a resin artcraft with an electric conduction function of claim 2, further comprising the step of baking said resin semi-finished good at a temperature ranging from 60 deg C. to 120 deg C. and in a time period ranging from 5 seconds to 20 seconds after said electrically conductive material is coated, so as to form said conductive layer on a surface of said resin semi-finished good.

4. The method of manufacturing a resin artcraft with an electric conduction function of claim 3, further comprising the step of baking said resin semi-finished good at a temperature from 60 deg C. to 120 deg C. and in a time ranging from 5 seconds to 20 seconds after said anti-oxidant material coated, so as to melt said anti-oxidant material and said conductive layer.

5. The method of manufacturing a resin artcraft with an electric conduction function of claim 4, further comprising a procedure performed after said resin semi-finished good is manufactured and before said electrically conductive material is coated onto a surface of said resin semi-finished good, said procedure comprising the steps of:
putting a dye into said electrically conductive material; and
mixing said dye with said electrically conductive material.

6. The method of manufacturing a resin artcraft with an electric conduction function of claim 5, wherein said electrically conductive material is coated onto a surface of said semi-finished good with a thickness ranging from 0.01 cm to 0.1 cm.

7. The method of manufacturing a resin artcraft with an electric conduction function of claim 5, wherein said stone powder is a marble powder.

8. The resin artcraft with an electric conduction function of claim 5, wherein said anti-oxidant material is a transparent paint.

9. A resin artcraft with an electric conduction function, comprising:
a casing, made of a resin and a stone powder;
an alternate layer, disposed on a surface of said casing and made of an electrically conductive material melted with an anti-oxidant material, and said electrically conductive material being attached on the surface of said surface, and a portion of said electrically conductive material being permeated into a surface of said alternate layer; and
an electric conduction circuit, installed in said casing, and electrically coupled to said electrically conductive material in said alternate layer.

10. The resin artcraft with an electric conduction function of claim 9, wherein said anti-oxidant material is a transparent paint.
